(19) United States
(12) Patent Application Publication
(10) Pub. No.: US 2010/0275662 A1
(43) Pub. Date: Nov. 4, 2010

(54) DOOR LOCK

(75) Inventors: Pasi Kervinen, Niittylahti (FI); Markku Jurvanen, Niittylahti (FI); Mika Purmonen, Joensuu (FI)

Correspondence Address: CHERNOFF, VILHAUER, MCCLUNG & STENZEL, LLP, 601 SW Second Avenue, Suite 1600, PORTLAND, OR, 97204-3157, US

(73) Assignee: ABLOY OY, Joensuu (FI)

(21) Appl. No.: 12/743,365

(22) PCT Filed: Nov. 6, 2008
(86) PCT No.: PCT/FI2008/050636

§ 371 Date: Jun. 18, 2010

(30) Foreign Application Priority Data
Nov. 20, 2007 (FI) 20075822

(51) Int. Cl. E05B 47/02; E05B 65/00

(52) U.S. Cl. 70/91; 70/277

(57) ABSTRACT

In an embodiment according to the invention, the controller for a solenoid in an electromechanical lock is arranged to generate motion power to move the solenoid plunger and holding power to hold the solenoid plunger in place so that the motion power generated consists of a higher power level and a lower power level that are alternating.

### FIELD OF TECHNOLOGY

The invention relates to an electromechanical lock equipped with a solenoid. The solenoid's operation is controlled with a controller.

### PRIOR ART

Electromechanical locks often use a solenoid to control deadbolting means in the lock so that the lock bolt is locked into the deadbolted position or the deadbolting means are released from the deadbolted position. A solenoid is also used to link the handle to other parts of the lock.

A typical solenoid comprises a coil fitted into a ferromagnetic body. A solenoid plunger, which is a metal rod, is located inside the coil and moved by means of a magnetic field generated around the coil. The movement of the solenoid plunger is utilised in lock mechanisms to achieve the desired action.

The operation of the solenoid is controlled by a controller also known as a solenoid controller. The purpose of the controller is to reduce the current consumption of the solenoid. FIG. 1 illustrates the current curve of a typical solenoid controlled by a controller. It is evident from the figure that at first, motion power 1 is routed to the solenoid to generate a sufficiently strong magnetic field to move the solenoid plunger. After a certain time, once the plunger has moved to the desired position, the current going through the solenoid is driven to holding power 2. Holding power is required to hold the solenoid plunger in the desired position as a solenoid typically employs a return spring to return the solenoid plunger to the initial position when the solenoid is unenergised. The total period of motion power and holding power is dimensioned to be sufficient for normal operation such as opening the door and/or turning the handle. The use of holding power reduces the current consumption of the solenoid. It is desirable to dimension the return spring to be as stiff as possible as confidence about the state of the unenergised solenoid is desired. More energy is required to put the solenoid plunger and the associated lock mechanism into motion compared to the energy required to hold it in place. The return spring is dimensioned with regard to the holding power in order to allow the solenoid to overcome the force of the return spring in all situations.

Electromechanical locks have relatively little space for the different components of the lock. Smaller electromechanical locks in particular require the use of smaller solenoids due to lack of space. However, the solenoid must be sufficiently large to generate the required power. Thus the problem (particularly with small solenoids) is that the solenoid must generate sufficient power while maintaining reasonable current consumption.

### SHORT DESCRIPTION OF INVENTION

The objective of the invention is to reduce the disadvantages of the problem described above. The objective will be achieved as described in the independent claim. The dependent claims describe various embodiments of the invention.

In an embodiment according to the invention, the controller 7 of a solenoid of an electromechanical lock 6 is arranged to generate motion power 3 to move the solenoid plunger and holding power 2 to hold the solenoid plunger in place so that the motion power generated is comprised of a higher power level 4 and a lower power level 5 that are alternating. Thus the motion power 3 is pulsating power that aims to overcome the friction forces working against the movement of the solenoid plunger. Pulsating motion power consumes less current than steady motion power.

### LIST OF FIGURES

In the following, the invention is described in more detail by reference to the enclosed drawings, where

FIG. 1 illustrates an example of a prior art lock solenoid controller current curve,

FIG. 2 illustrates an example of a lock solenoid controller current curve according to the invention, and

FIG. 3 illustrates a simplified example of an embodiment according to the invention.

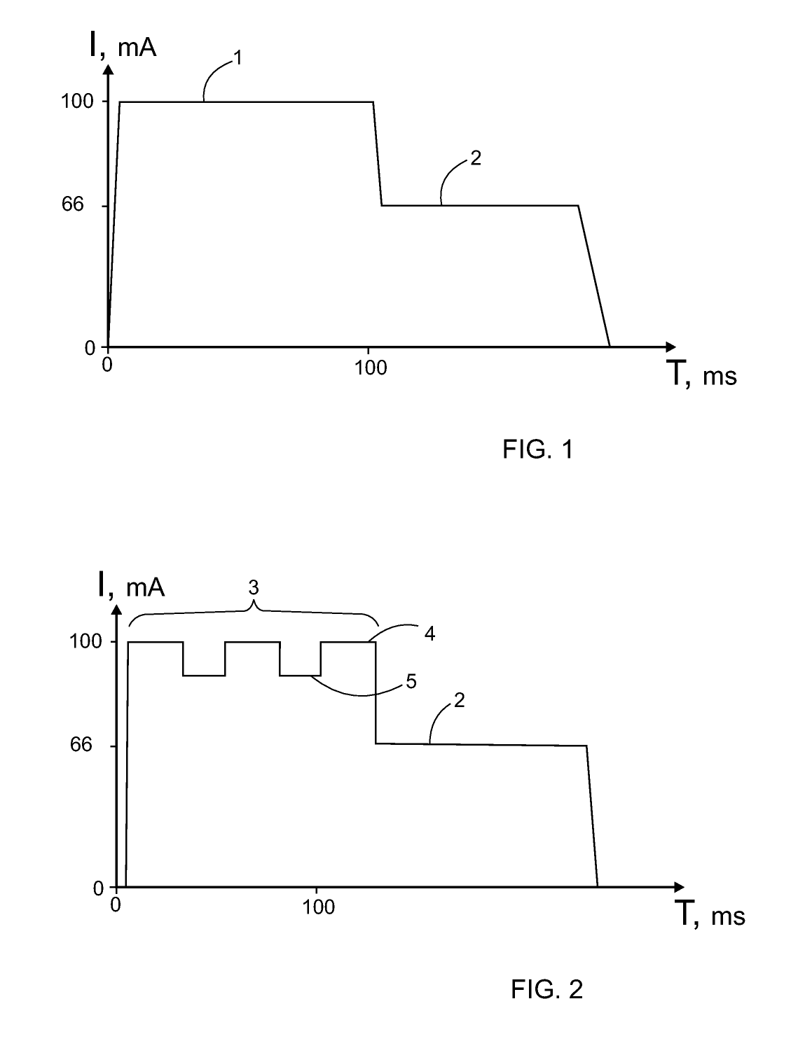

### DESCRIPTION OF THE INVENTION

FIG. 2 illustrates a solenoid controller current curve according to the invention, in which the motion power 3 consists of a higher power level 4 and a lower power level 5. The power can be represented, for example, with the formula P=UI, in which U is voltage and I is current. When the voltage and/or current level is varied, the power level also varies. This text speaks of power levels but it is clear that the desired power level can be implemented by controlling the voltage or current. The power levels 4, 5 are alternating, creating a variable power range 3. A pulsating force is imposed on the solenoid plunger within this power range. Pulsating power helps to overcome friction forces. The locking mechanism may be loaded (for example, door sealing strips), which makes it more difficult to put the solenoid plunger in motion. In other words, the solenoid plunger can be put in motion with less power if alternately repeating levels of motion power are used.

The period of motion power is dimensioned so that the solenoid plunger can be moved to the desired position. Approximately 130 ms is appropriate for most applications. It is preferable that the motion power range 3 starts with a higher power level. For example, three higher power levels and two lower power levels, among which the first level is a higher power level, constitute a very well-functioning solution. The duration of the higher power level 4 can be, for example, 25 to 35 ms, and the duration of the lower power level 5 can be 15 to 25 ms. In practice, periods of approximately 130 ms (or another period of motion power) can be repeated as desired, for example at intervals of 1 second or 3 seconds. This is convenient, for example, when a user is pressing the lock handle, preventing the solenoid plunger from moving. In this case, the solenoid will not warm up excessively because the duration of the higher power level is limited and it is repeated at certain intervals, while the user may have ceased pressing the handle.

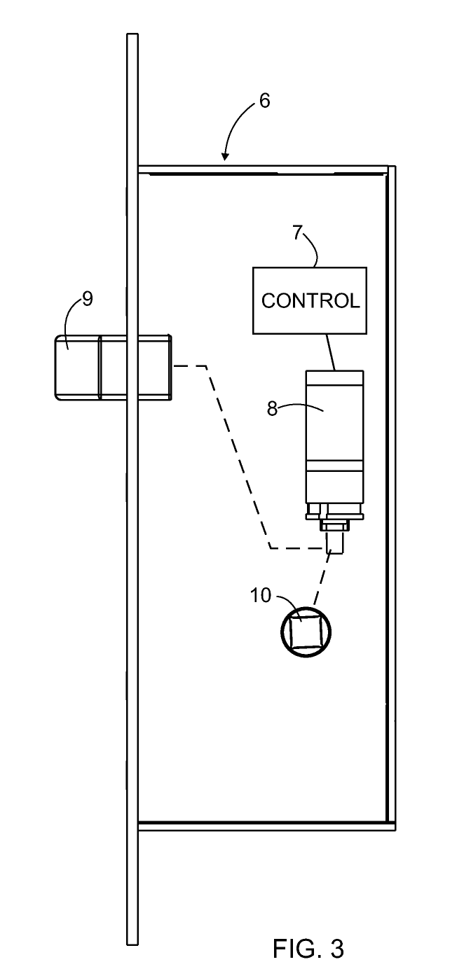

FIG. 3 illustrates a simplified example of equipment according to the invention, in which the electromechanical lock 6 comprises a solenoid 8 and a solenoid controller 7. The solenoid is arranged to control either the bolt 9 or the functional linkage between the lock handle and the rest of the lock mechanism 10. The controller 7 is arranged to generate the motion power consisting of alternating power levels as described above. In handle-controlled locks, when the handle is pressed and the solenoid 8 receives a control command, the link between the handle and the rest of the mechanism is more secure when the handle is released. The solenoid operating voltage is normally 10 to 30 volts direct current. The operating voltage is modified by pulse-width modulation (PWM), for example, which creates the desired current and power level.

The solenoid controller 7 is a processor within the lock, for example. It can also be an electric circuit customised for the purpose.

Because variable-level motion power consumes less power than steady motion power at a high level, energy is saved. This also allows a smaller solenoid to more securely move the desired lock mechanisms. The load on the power supply is also smaller. Variable-level motion power allows the use of a stronger spring pulled by the solenoid. The return spring can be dimensioned in accordance with the motion power. Repeating the motion power will correct any changes in state. This makes lock operation more reliable. Also, the solenoid will not warm up unnecessarily.

As can be noted, an embodiment according to the invention can be achieved through many different solutions. It is thus evident that the invention is not limited to the examples mentioned in this text. Therefore any inventive embodiment can be implemented within the scope of the inventive idea.

1-6. (canceled)

7. A controller (7) of a solenoid (8) of an electromechanical lock (6), arranged to generate motion power (3) to move a solenoid plunger and holding power (2) to hold the solenoid plunger in place, levels of said powers being created by pulse-width modulation,
characterized in that the motion power (3) to be generated is comprised of a higher power level (4) and a lower power level (5) that are alternating, said higher and lower power levels being created by pulse-width modulation.

8. A controller according to claim 7, characterized in that the motion power (3) comprises three higher power level ranges (4) and two lower power level ranges (5), said motion power starting in the higher power level range.

9. A controller according to claim 7, characterized in that the duration of the higher power level is 25 to 35 ms and the duration of the lower power level is 15 to 25 ms.

10. A controller according to claim 7, characterized in that the motion power is arranged to be repeated at a desired interval.

11. An electromechanical lock (6) comprising a solenoid (8) and a solenoid controller (7), characterized in that the solenoid controller (7) is compliant with claim 7.

12. A door lock according to claim 11, characterized in that the controller is a processor or an electric circuit.
